(19) United States
(12) Patent Application Publication
(10) Pub. No.: US 2015/0296331 A1
(43) Pub. Date: Oct. 15, 2015

(54) BLUE TOOTH COMMUNICATION SYSTEM FOR MOBILE

(71) Applicant: TOPTEAM TECHNOLOGY TAIWAN CO; LTD., TAICHUNG CITY (TW)

(72) Inventors: Wen-Sen Lin, Taichung City (TW); Wanshone Chiou, Taichung City (TW)

(73) Assignee: TOPTEAM TECHNOLOGY TAIWAN CO; LTD., TAICHUNG CITY (TW)

(21) Appl. No.: 14/248,362

(22) Filed: Apr. 9, 2014

(51) Int. Cl. H04W 4/02; H04W 4/00

(52) U.S. Cl. CPC H04W 4/02; H04W 4/008

(57) ABSTRACT

A blue tooth communication system for a mobile device includes a mobile device and a cooperated device. The mobile device has a blue tooth module. The cooperated device has a blue tooth module and a radio emitting-receiving module. The blue tooth module of the cooperated device is in communication with the blue tooth module of the mobile device. A network is established between the user with the blue tooth communication system and different users with the same systems. The user is able to send messages, pictures and precise positions by using GPS. When there is no service signals for the mobile device, the system is used as a radio communication device.

### BACKGROUND OF THE INVENTION

1. Fields of the Invention

The present invention relates to a blue tooth communication system, and more particularly, to a blue tooth communication system for a mobile device.

2. Descriptions of Related Art

The conventional mobile devices such as cellular phones are used widely for communication without being restricted by wires and can be functions almost any place in the world when the service signals are available. When hiking, the hikers are equipped with the mobile devices so as to communicate with friends when in emergent cases. However, the weather conditions and the terrains may affect the receiving of the service signals, some remote areas cannot receive signals clearly. The users are equipped with radio equipment or satellite phones to ensure a reliable communication. Nevertheless, the radio equipment and satellite phones are expensive and not affordable for most of the users. The users may be in risk due to no communication with outside when in emergency if no service signals are available.

The present invention intends to provide a blue tooth communication system for a mobile device to improve the shortcomings mentioned above.

### SUMMARY OF THE INVENTION

The present invention relates to a blue tooth communication system for a mobile device, and comprises a mobile device having a display of user-device interface, a control unit, an application and a blue tooth module. The display of user-device interface and the application are downloaded to the mobile device. The application has functions of sending signals, talking and global positioning by using Global Positioning System (GPS). The blue tooth module is established in the mobile device. A cooperated device has a blue tooth module and a radio emitting-receiving module. The blue tooth module of the cooperated device is in communication with the blue tooth module of the mobile device. The control unit and the application are activated by operating the display of the user-device interface. The functions of sending messages, talking and/or global positioning by using Global Positioning System (GPS) are used and sent to the blue tooth module of the cooperated device via the blue tooth module of the mobile device. The contents of the sending messages, the talking and/or the global positioning by using Global Positioning System (GPS) are transmitted to one or more than one blue tooth communication systems of mobile devices. When there is no service signals for the mobile device, the system is used as a radio communication device.

Preferably, the display of the user-device interface comprises one of a message button, a talk button and a GPS button or any combination of the message button, the talk button and the GPS button.

Preferably, the display of the user-device interface comprises a transfer button.

Preferably, the function of talking of the application is used for two-way sending and receiving.

Preferably, the function of sending messages of the application is used for sending words; digits and pictures.

The primary object of the present invention is to provide a blue tooth communication system for a mobile device, wherein a network is established between the user with the blue tooth communication system of the present invention and different users with the same systems. The user is able to send messages, pictures and precise positions by using GPS. When there, is no service signals for the mobile device, the system is used as a radio communication device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the components of the mobile device and the components of the cooperated device of the of the present invention;

FIG. 2 shows that the mobile device shows the user-device interface;

FIG. 3 shows a user using the blue tooth communication system of the present invention, and

FIG. 4 shows that the user operates the blue tooth communication system of the present invention to send message to other blue tooth communication systems of mobile devices.

### DETAILED DESCRIPTION OF THE PREFERRED EMBODIMENT

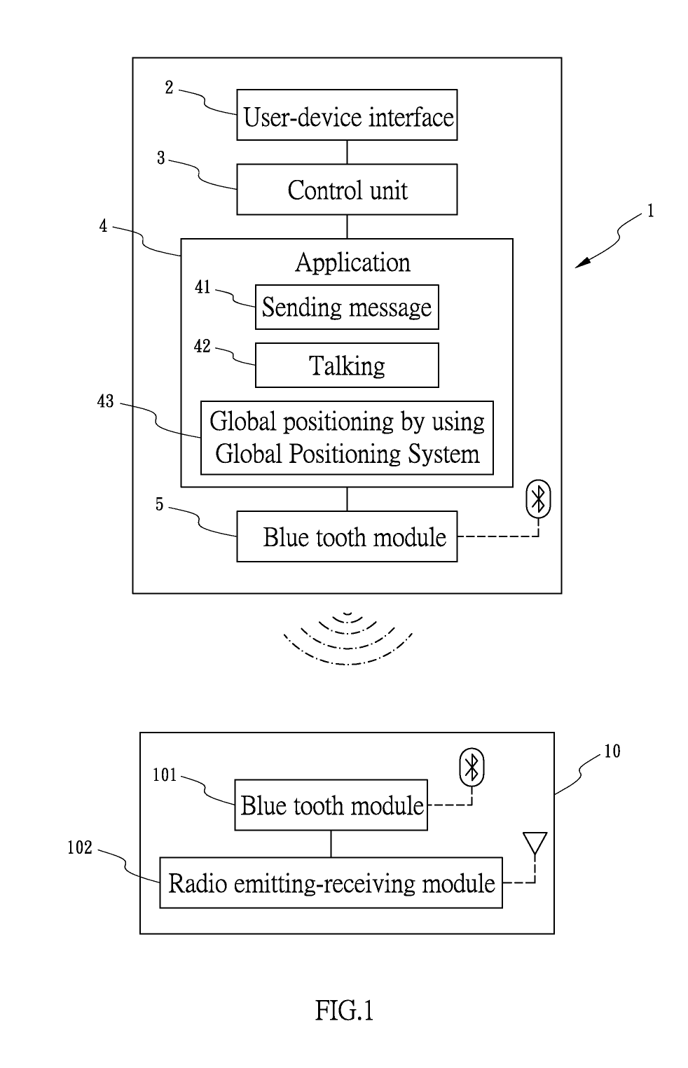

Referring to FIG. 1, the blue tooth communication system for a mobile device of the present invention comprises a mobile device 1 and a cooperated device 10. The mobile device 1 comprises a display of user-device interface 2, a control unit 3, an application 4 and a blue tooth module 5. The display of user-device interface 2 and the application 4 are downloaded to the mobile device 1. The application 4 has the functions of sending signals 41, talking 42 and global positioning by using Global Positioning System (GPS). The blue tooth module 5 is established in the mobile device 1.

The cooperated device 10 comprises a blue tooth module 101 and a radio emitting-receiving module 102, wherein the blue tooth module 101 of the cooperated device 10 is in communication with the blue tooth module 5 of the mobile device 1.

When in use, the control unit 3 and the application 4 are activated by operating the display of the user-device interface 2, the user operates the function of sending messages 41, talking 42 and/or global positioning by using Global Positioning System (GPS) 43, and the different types of contents of the sending messages, the talking and/or the global positioning by using Global Positioning System (GPS) 43 are then sent to the blue tooth module 101 of the cooperated device 10 via the blue tooth module 5 of the mobile device 1. The contents of the sending messages 41, the talking 42 and/or the global positioning by using Global Positioning System (GPS) 43 are then transmitted to one or more than one blue tooth communication systems of other mobile devices. Therefore, the information can be sent to other blue tooth communication systems of mobile devices via the mobile device 1 and the cooperated device 10 of the user. Even if there is no service signals, the system of the present invention can be used as a radio communication device to communicate with people outside of the site when in emergency.

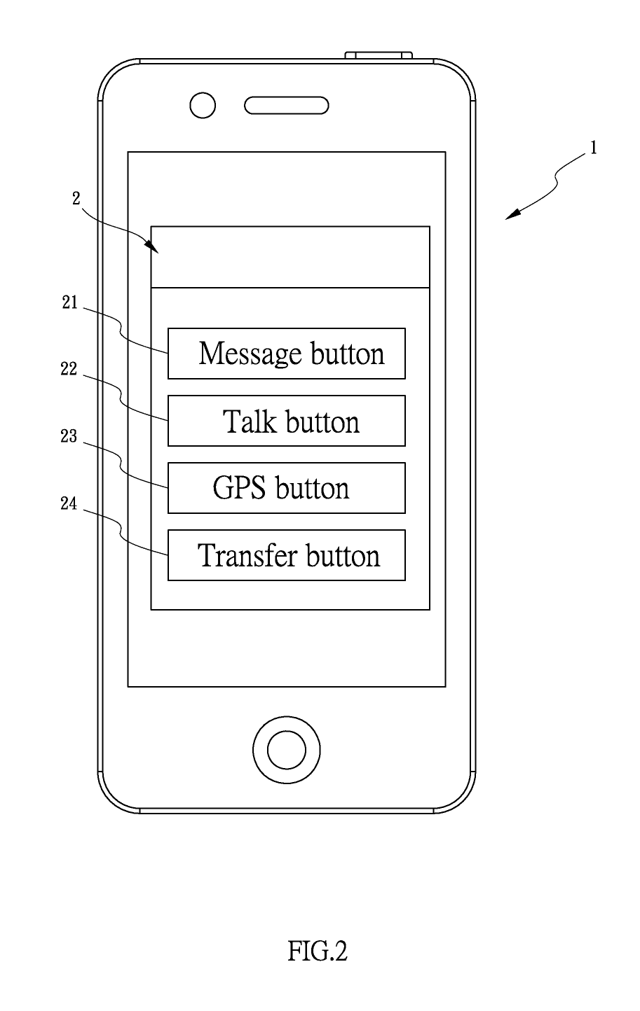

As shown in FIG. 2, the display of the user-device interface 2 comprises one of a message button 21, a talk button 22, a GPS button 23 and a transfer button 24, or any combination of the message button 21, the talk button 22, the GPS button 23, a transfer button 24. The function of sending messages 41 of the application 4 is used for sending words, digits and pictures. Therefore, the user can send the user's information, the description about the situations and conditions he/she is encountered, and the pictures or photos of the site to the rescue units to be compared with so as to check the position where the user is located. By using the GPS button 23, the precise position of the coordinate defined by GPS can be sent. The coordinate information can also be displayed in form of digits or words via the function of sending message 41. The function of talking 42 of the application 4 is used for two-way sending and receiving so that the user can communicate with other people by operating the talk button 22.

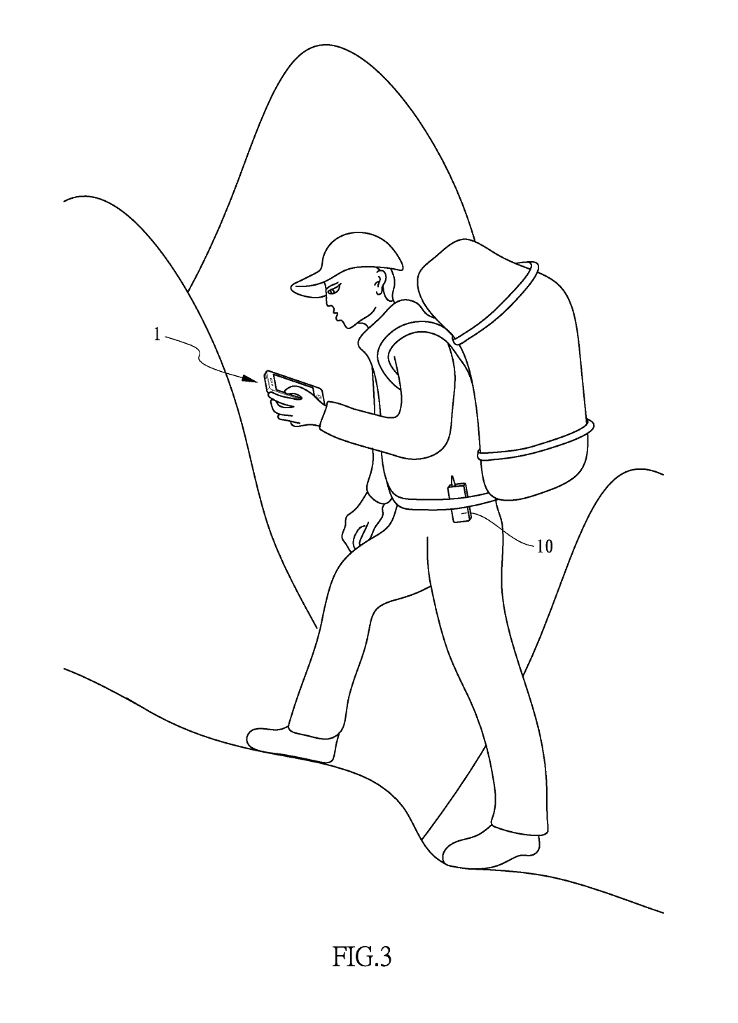

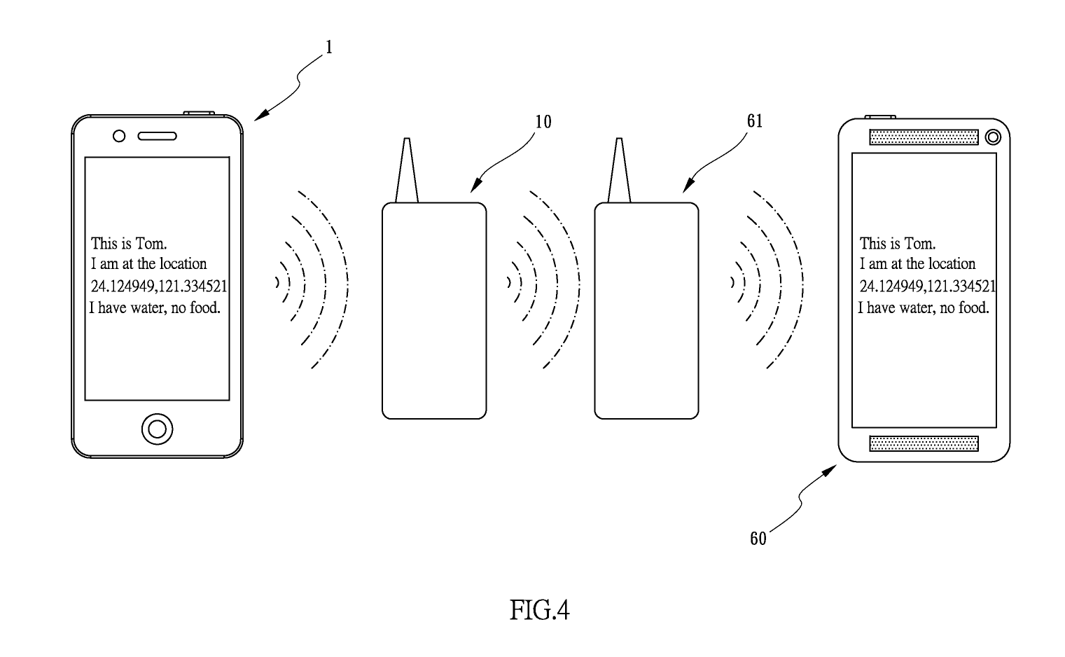

As shown in FIGS. 1 to 4, when the user in a mountain for example, and wants to communicate with people outside of the mountain, and there is no service signals for the mobile device 1 due to weak signals of the GSM (Global System for Mobile Communications), the user operates the mobile device 1 with the blue tooth communication system of the present invention to send messages by using the function of sending messages 41 of the application 4 in the forms of words, digits and pictures to let the people outside pf the mountain know the conditions of the supply of food and water. The messages are sent to the blue tooth module 101 of the cooperated device 10 by the blue tooth module 5 of the mobile device 1. The messages are then sent to the people who have the cooperated devices 61 with the same type of the blue tooth communication system of mobile device 1 of the present invention. The cooperated devices 61 then send the messages to the mobile devices 60 via the blue tooth transmission. The people outside of the mountain can get the necessary information of the user from their mobile devices 60. When there is no service signals for the mobile device 1, the system is used as a radio communication device by operating the function of talking 42 of the application 4 which is used for two-way sending and receiving.

While we have shown and described the embodiment in accordance with the present invention, it should be clear to those skilled in the art that further embodiments may be made without departing from the scope of the present invention.

What is claimed is:

1. A blue tooth communication system for a mobile device, comprising:
a mobile device having a display of user-device interface, a control unit, an application and a blue tooth module, the display of user-device interface and the application being downloaded to the mobile device, the application having functions of sending signals, talking and global positioning by using Global Positioning System (GPS), the blue tooth module being established in the mobile device;
a cooperated device having a blue tooth module and a radio emitting-receiving module, the blue tooth module of the cooperated device being in communication with the blue tooth module of the mobile device, and
the control unit and the application being activated by operating the display of the user-device interface, the function of sending messages being used to send messages, the function of talking being used to talk and/or the function of global positioning by using Global Positioning System (GPS) being used to position the movable device, contents of the messages, the talking and/or the global positioning being sent to the blue tooth module of the cooperated device via the blue tooth module of the mobile device, the contents of the sending messages, the talking and/or the global positioning by using Global Positioning System (GPS) being transmitted to one or more than one blue tooth communication systems of other mobile devices.

2. The blue tooth communication system for a mobile device as claimed in claim 1, wherein the display of the user-device interface comprises one of a message button a talk button and a GPS button, or any combination of the message button, the talk button and the GPS button.

3. The blue tooth communication system for a mobile device as claimed in claim 1, wherein the display of the, user-device interface comprises a transfer button.

4. The blue tooth communication system for a mobile device as claimed in claim 1, wherein the function of talking of the application is used for two-way sending and receiving.

5. The blue tooth communication system for a mobile device as claimed in claim 3, wherein the function of talking of the application is used for two-way sending and receiving.

6. The blue tooth communication system for a mobile device as claimed in claim 1, wherein the function of sending messages of the application is used for sending words, digits and pictures.

7. The blue tooth communication system for a mobile device as claimed in claim 3, wherein the function of sending messages of the application is used for sending words, digits and pictures.

8. The blue tooth communication system for a mobile device as claimed in claim 4, wherein the function of sending messages of the application is used for sending words, digits and pictures.

9. The blue tooth communication system for a mobile device as claimed in claim 5, wherein the function of sending messages of the application is used for sending words, digits and pictures.
